(19) United States
(12) Patent Application Publication
(10) Pub. No.: US 2009/0078762 A1
(43) Pub. Date: Mar. 26, 2009

(54) RFID TAG

(75) Inventors: Deborah Anne Forster, York (GB); Peter Viner, West Yorkshire (GB)

Correspondence Address: JACOBSON HOLMAN PLLC, 400 SEVENTH STREET N.W., SUITE 600, WASHINGTON, DC, 20004, US

(73) Assignee: STAYPUT TAG LIMITED, Yorkshire (GB)

(21) Appl. No.: 12/083,546

(22) PCT Filed: Sep. 25, 2006
(86) PCT No.: PCT/GB2006/003542

§ 371 Date: Oct. 3, 2008

(30) Foreign Application Priority Data
Sep. 23, 2005 (GB) 0519453.5

(51) Int. Cl. G06Q 10/00; G08B 13/00; G06K 7/00

(52) U.S. Cl. 235/385; 340/572.8; 235/439

(57) ABSTRACT

An attachable RFID tag is described having a containment head portion (1) containing a passive RFID transponder (8) and an attachment portion comprising an elongate projection therefrom, which projection is discontinuously threaded, with a screw-threaded portion (5) and an unthreaded portion (6) of longitudinal extent greater than the thickness of the item to be tagged. A tagging system and a method of tagging and of operating a tagging system are also described.

The invention relates to an attachable passive radio frequency identification (RFID) transponder tag for attachment to an item to be tagged. The invention in particular relates to a tag incorporating such a transponder which is provided with a convenient means to attach the tag essentially permanently to an item, in the sense that the attachment means ensures that the tag can be attached readily but not readily removed.

Passive RFID devices are used in an increasingly wide range of applications to mark various items for diverse purposes, to enable subsequent identification, authentication, tracking etc of the articles. For example, RFID tags might be attached to goods, and in particular fabric and like goods such as clothing, linen etc, or to livestock, packaging, or any other items where there might be a desire to identify, authenticate, track or otherwise provide some form of attached reference to the goods.

For many applications, the principal requirement is that a simple passive RFID tag is provided which can be readily attached by a user to the item to be tagged, in particular to allow the tagging of multiple such items in rapid and convenient manner. It will often be desirable that a tag so attached is retained in a relatively permanent manner, in that it is not so readily removable. There is thus a general desire, in relation in a range of tagging applications, to provide a tag which incorporates a passive RFID transponder in a design which facilities convenient and cheap mass production and allows rapid attachment of the tag to multiple goods by a user in a quick and convenient manner.

A particular example of a tagging application where such a requirement is likely to arise is described with reference to the laundry business. The present invention is particularly suited to use in a laundry tagging system for tagging multiple items to be laundered, but such a system is described for illustrative purposes only, and the invention is applicable to the tagging and marking of a wide range of items.

Items of laundry, whether clothing, bed linen or other items, may be tagged to facilitate processing by a laundry in various situations. A laundry or laundry department which serves a business that has occasion to wash large volumes of laundry items of its own ownership, for example a hotel, restaurant, residential care home, other residential establishment, establishment supplying hire clothing such as uniforms or the like, might wish to tag laundry items for a range of information or identification purposes, for example to facilitate smooth handling of items. Most particularly, a laundry which handles items from a variety of owners, such as a hotel, residential care home or the like, or commercial laundry, will have a particular requirement to tag laundry so as to be able to identify ownership and track the item to ensure that it is returned to the correct owner.

The invention in particular relates to situations where a laundry expects to handle multiple items repeatedly for its multiple owners, as might for example be the case in a residential care home or the like, and where it is therefore desirable to have an effective way of tagging items that can be expected to be repeatedly processed so as to ensure ownership is correctly tracked and identified, and consequently of tagging items with a tag that is permanent and stable over repeated laundry cycle.

Traditionally, fabric labels might be attached by a laundry to an item of clothing, perhaps carrying a simple reference code. More sophisticated laundry tag labels have included readable barcodes. These might be referenced to a suitable database on which is stored information concerning, for example, ownership details, processing instructions, laundering, drying and ironing conditions and the like. The greater information which can be stored on a barcode can be used in conjunction with such a database to improve accuracy of tracking, ensure items are not lost, and automate some stages of the laundry process.

It has been suggested that a passive radio frequency identification (RFID) transponder might be used as an identification device as a more sophisticated alternative to a barcode. Such a device might carry more information, and can be read from a limited distance. However, prior systems have not necessarily offered solutions which are easy to attach, for example sewing or other permanently incorporating a tag into an item.

Solutions involving the sewing in of a tag, or otherwise involving the permanent attachment of a tag by its fabrication into the garment or other laundry item are not so practical in application to the multiple-owner laundry situation, where it is desirable to have tags which can be attached rapidly to individual laundry items by the laundry operator as and when the owners require use of the laundry service.

Further examples of tagging applications where such a requirement is likely to arise can be envisaged readily, especially in relation to clothing items, for example as a means to effect stock control, as a means for authentication of high value brands etc. The invention is particularly suited to the application of multiple tags for multiple items to carry limited information allowing cross-reference to a stock control or authentication database.

The present invention is particularly suited to use in a laundry tagging system for tagging multiple items to be laundered, but such a system is described for illustrative purposes only, and the invention is applicable to the tagging and marking of a wide range of items.

It is an object of the invention to provide an attachable RFID tag, which mitigates some or all of the above disadvantages.

It is a particular preferred object of the invention to provide a readable RFID tag which is inherently readily attachable to an object to be tagged, for example clothing or other laundry items, to allow for the individual identification of an item, for example to refer to a database of owners and ensure that information concerning the item, and for example its ownership, can be tracked for control and identification purposes.

It is a particular preferred object of the invention to provide a readable RFID tag that can assist in the authentication of high value items.

It is a particular preferred object of the invention to provide a laundry tag for identification of, for example, the owner of an item of laundry, especially a tag which can be attached in a permanent but unobtrusive manner to be effective through multiple laundry cycles.

Thus, in accordance with the invention in the first aspect, an attachable RFID tag comprises a containment head portion containing a passive RFID transponder and an attachment portion comprising an elongate projection therefrom, which projection is discontinuously threaded, with a screw-threaded portion and an unthreaded portion of longitudinal extent greater than the thickness of the item to be tagged.

An unthreaded portion is provided between a threaded portion of the projection (located generally distally of the containment head portion for the RFID transponder) and the containment head portion. In accordance with such an arrangement, attachment is effected in that the threaded portion is driven through the item to be tagged. This may be through a suitable, optionally complementarily threaded, aperture in the item to be tagged, or through a similar aperture provided in a tag receiving unit (provided as part of a two part tagging system as is described in an embodiment below) or simply directly through the item to be tagged. The screw-thread may self tap into the item to be tagged. Regardless, once the threaded portion is driven through the item to be tagged and into an attached position to its full extent, it is so configured that the unthreaded portion then sits loosely and free to rotate. The threading process is thus not readily reversible by a screw action.

In this way, a tag in accordance with the invention is readily attachable to an item to be tagged, whether directly, via a suitable prepared aperture, or in association with a complementary attachment unit, but cannot readily be removed by reversing the screw action.

Thus, a tag in accordance with the invention is readily and rapidly attached to an item to be tagged. In particular, it is attachable to a fabric item such as an item of clothing or linen, for example, a laundry item of a user of a laundry service, a stock item for stock tracking or brand authentication. This is much more practical than a sewn in tag, whether incorporated at the time of manufacture of the item or otherwise, would be. The tag is simply attachable to the item by the laundry provider or stock holder as and when the need arises.

In an embodiment, the tag comprises a head including a transponder as hereinbefore described, and a projecting portion having a threaded distal end, and an unthreaded shank between the threaded distal end and the head, the unthreaded shank being in longitudinal extent at least the thickness of the item to be tagged. Such a screwing arrangement can self tap through an item to be tagged, for example the laundry item or other clothing item, and drive fully through a recess in the item to be tagged until such point as the shank sits loosely and freely rotates within the recess, and reversing the screw action to detach is no longer easily possible.

The threaded portion is conveniently suitably shaped, for example, being tapered towards the distal end and/or presenting a generally planar reward engagement face, to facilitate engagement and/or inhibit disengagement as described.

At its simplest, the tag of the invention merely comprises a partially-threaded attachment projection as described, which itself effects essentially permanent attachment of the tag, and the incorporated RFID transponder in the containment head, to an item to be tagged. In many instances, for example when the tag is to be attached to a sheet material, such as an item of clothing or linen, the screw-threading alone may be sufficient to drive the tag into the material and into its attached position where the unthreaded portion is free to rotate, so that reversing the screw action does not tend to withdraw the projection. Alternatively, an aperture may be provided in an item to be tagged such as a plastic sheet, to assist the self-tapping of the thread through the item.

Alternatively, in a possible embodiment, a tag in accordance with the invention is adapted to effect attachment to an item to be tagged with the assistance of a complementarily recessed tag receiving unit, which tag receiving unit comprises a body portion having a through aperture therein to receive the partially threaded projection of the tag. In use, the tag and receiving unit are placed either side of the item to be tagged, and the tag is driven by a screwing action until the threaded portion passes through not only the item to be tagged (either via a prepared aperture therein or merely by being driver therethrough) but the recess in the receiving unit. The threaded portion may self-tap therethrough.

In this fully attached configuration, the unthreaded portion freely rotates within the recess, and the tag is not readily separated from the tag receiving unit, and therefore not readily removed from the tagged item. In this way, the tag and receiving unit respectively serve as complementary male and female attachable tag portions.

In a preferred embodiment the head portion containing the RFID transponder is disc like, with the RFID comprising a coil disposed toward the circumference of the disc, conveniently around a centrally located projection extending generally perpendicularly thereto.

In a particularly preferred embodiment, the tag comprises a generally flat disc having a projecting member extending generally perpendicularly from a centre thereof, and is provided with a tag receiving unit comprising a generally flat annulus with a centrally located aperture suitably sized and shaped to receive the said projection.

It is desirable for the tags to be as unobtrusive as possible, since the intention is that they will be permanently attached to the item of clothing. To facilitate this, they are preferably attached in as unobtrusive a site as possible. They are also preferably small, for example with a maximum dimension across (and in the case of a disc with a diameter) of less than 15 mm and most preferably less than 10 mm.

At this small size, any incorporated RFID transponder can carry only a limited amount of information. Accordingly, it is intended in use that each transponder will carry merely a numerical identifier, which will be read with reference to a stored database from which more detailed information can be retrieved for example to identify the item, to authenticate it as a genuine branded item, to track it through a laundry or stocking or distribution system. The identifier will enable a connection to be made to the database to draw information therefrom, for example its description, size, brand, model, batch and like details for identification purposes, its ownership, laundry or care instructions, ongoing delivery instructions, location etc as part of a stock control and for example laundry system, or means to authenticate as genuine, for example comprising an authentication code in the database usable in conjunction with the identifier to authenticate in a manner that merely copying the identifier would not permit. The identifier may be unique to an item or class of items, classified eg by type, brand, owner or in any other manner.

The power of the invention lies in combining this limited readable identifier information with a product information database or location database or authentication database to generate much more useful information or functionality than could be stored on a small transponder alone. Nevertheless, it is preferable that each transponder has at least a 32-bit, and more preferably a 64-bit identifier capacity.

In accordance with the invention, the tag is fixedly retained in a manner intended to be permanent or semi-permanent, which in this context is to say that it is not intended to be removable at least during the normal course of use.

In use in accordance with the example as a laundry tag, a laundry item is thus permanently and irreversibly labelled, and at the end of its useful life the tag is discarded with the laundry item or destroyed to effect removal.

This is achieved in that the attachment mechanism provided by the partial thread is inherently not reversible, so that an attached tag cannot so easily be released without damaging the tag or item.

The discontinuous threading alone is fundamentally how this is achieved. However, more detailed features of shape or configuration, or additional material features, may be provided to enhance the effect.

In particular, in a preferred embodiment, the threaded portion is suitably shaped to facilitate insertion and/or restrict withdrawal. For example, the threaded portion of the projection has an area of generally tapering cross section, tapering to a minimum, and for example tapering to a point, distally from the head portion containing the transponder. As a screw is driven into an item to be tagged in use, it presents a threaded portion of progressively increasing cross section, which facilities its insertion. Such a profiling also allows for the provision, in a preferred embodiment, of a circumferential detent at an end of the threaded portion proximal to the head, immediately adjacent the unthreaded portion, in that the threaded portion at this point is of greater cross sectional area than the unthreaded portion. This will tend to resist withdrawal of the projection once it is fully inserted.

In all cases, both the threaded and unthreaded portions are preferably circular in cross section. The transponder containing head may be any shape to assist the threading process.

Additionally or alternatively frangible/permanently deformable elements may be provided within a recess or aperture and/or a projecting member so acting as to inhibit separation once the two portions are attached.

Additional or alternatively a fusible portion may provide to be fused under the action of a suitable attachment tool to create a permanent connection and/or glue may be applied.

Thus the attachment of the tag to the item is intended to be permanent rather than removable, and the tag is capable of remaining connected during normal use. For example, as a laundry tag it remains connected in normal laundry conditions through multiple laundry cycles to give the individual item of laundry a potentially unique and readily readable identification number which can be referred to a suitable database.

In the embodiment as a laundry tag, there is a need for the tag to withstand repeated wash and iron cycles. The flat profile and permanent fixing helps, but the RFID device must be protected from an environment which is particularly harsh, both chemically and in terms of temperature. Accordingly, the RFID must be provided with a protective covering to withstand temperatures of at least 125° C., and more preferably temperatures of at least 200° C., and to withstand the harsh chemical environments typically encountered in the laundry situation. Most conveniently, this is achieved in that the RFID coil is encapsulated entirely within the containment portion of the tag. Other situations can also be envisaged where it might be desirable for the tag to remain intact during article life, and not merely to point of sale, and hence withstand repeated wash and iron and wear cycles.

This imposes a material requirement on the material of at least that portion of, and preferably the entire, tag. It must have good thermal and chemical stability. In the preferred embodiment it should not interfere excessively with the reading of the encapsulated RFID coil. Nevertheless it is also desirable that the tag is readily fabricated via a mass production technique. Preferably, the casing material of the tag comprises polymeric material with the necessary temperature and chemical stability, and is for example nylon or PPS (polyphenylene sulfide).

The encapsulated RFID transponder is a coiled antenna of suitable conductor with suitable memory chip as will be familiar.

The precise frequency of operation is not considered critical to the invention. The standard ISO 18000 for air interface communication frequencies is relevant, and the tag is preferably adapted to operate at, and the system described below adapted to operate at one of these standard protocols. A preferred frequency for operation is 13.56 MHz.

In accordance with a further aspect the invention preferably comprises a tagging kit comprising a plurality of tags as hereinbefore described each carrying an identifier, and further provided with at least one tag reader. The tag reader includes in familiar manner a suitable radio frequency transmitter and receiver to read an identifier given to each tag. An identifier may be unique to an item or class of items, classified eg by type, brand, owner or in any other manner, and the plurality of tags therefore comprises a plurality of tags each with a unique identifier or a plurality of tags in each class to be identified with a specific class identifier as the case may be.

The tagging kit may optionally further include a tag attachment device that assists in driving the thread into its attached position where the unthreaded portion is free to rotate, and where a two-part tag is offered, assist mating of the male and female portions.

In accordance with a further aspect of the invention a multi-item management system in particular a clothing management system and for example a laundry management system, a stock control system, or a stock authentication system, comprises a tagging kit as above described, preferably including a plurality of data readers, and further comprising a data register to store information associated with each tag identification number, which information comprises details concerning the item, for example its description, ownership, laundry or care instructions, ongoing delivery instructions, location, size, brand, model, batch and like details, or means to authenticate as genuine or the like. An identifier may be unique to an item or class of items and hence reference data specific to that item or to that class of items as the case may be.

Preferably, the system further comprises a data communications link to facilitate data communication between a tag reader and the data register, and a display means to display information to a user.

In accordance with a further aspect of the invention, a method of tagging an item and for example an item of laundry to enable its tracking comprises

fabricating a tag having a partially threaded projecting portion as above described;
incorporating therewithin in the containment head thereof, and in particular encapsulating therewithin a passive RFID transponder;
attaching the tag by causing the projecting portion to rotate and driving the same into an item to be tagged until the threaded portion passes through the item to be tagged and the unthreaded portion is left freely to rotate therewithin and in particular for example attaching the same on a fabric portion of an item of laundry or clothing, or on an attached label or other convenient point, such as to effect a fixed and permanent attachment of the tag to the item.

In a further aspect of the invention a method of operation of a tagging system for example a laundry tagging system to identify data concerning an item for example at least the owner of individual items of laundry within the system comprises the steps of:

attaching a tag to each item in accordance with the method of the previous aspect;
providing at least one radio frequency tag reader capable of reading the identifier on each tag;
providing a data register in data communication link with the said tag reader to store information relating to each identifier, for example including at least the owner of the laundry item;
as and when necessary, reading the tag with the reader, retrieving the identifier, passing the identifier to the data register via the data communication link, and thereby retrieving at least some of the stored information, and in particular the information identifying the owner of the laundry item.

In accordance with the invention, a simple, user-attachable tag is provided which can be read at a distance and associated with a database of information.

In a possible use this may include in particular ownership information and so the tag lends itself exceptionally well to the handling of laundry items for multiple owners, for example in a residential situation such as residential care home.

The invention will now be described by way of example only with reference to the figures in which:

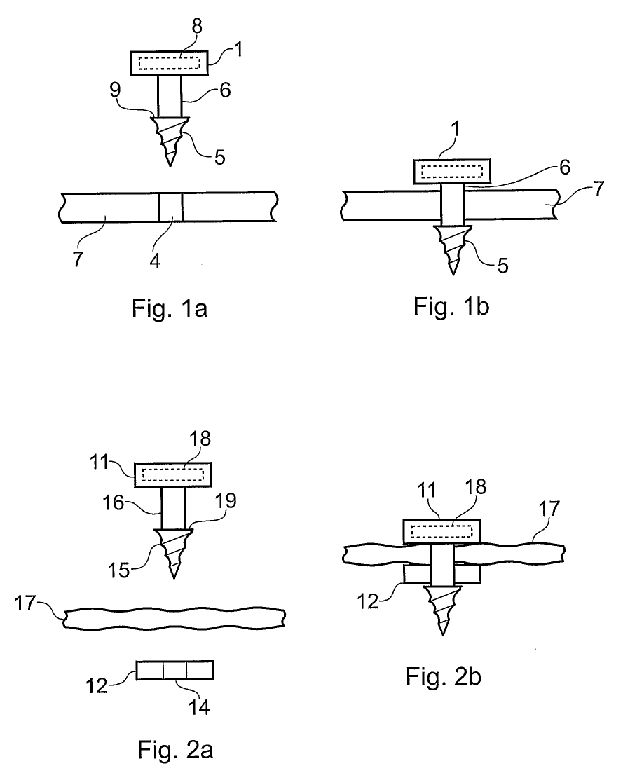

FIG. 1 which illustrates a tag in accordance with the invention;

FIG. 2 illustrates an alternative tag.

Referring to FIG. 1, the tag comprises a head (1) consisting of a disc of rigid plastic material which is approximately 2 mm thick and approximately 12 mm in diameter. The disc entirely encapsulates and protects an RFID coil (8).

The disc is attached to an item (7), which in the example is a resilient item such as a stiff fabric or sheet of plastic or the like. Attachment is by means of the perpendicular projection, and the tag is shown unattached in FIG. 1 (a) and attached in FIG. 1 (b).

The projection consists of a threaded portion (5) which is tapered to a point at a distal end and an unthreaded shank (6). The shank is of greater longitudinal extent than the thickness of the item to be tagged. The tapered shape of the threaded portion (15), tapering to a greater diameter than the diameter of the unthreaded portion (16), allows the creation of a conical detent with a rearward surface (19).

In use the threaded portion threads its ways through the fabric (7) when rotated, self tapping through the recess (4). The threaded portion is driven fully through the fabric (7) until such point as the unthreaded shank portion (16) sits within the aperture. In this configuration, the tag simply freely rotates, and cannot be withdrawn merely by reversing the action of the screw. The conical detent created by the tapered shape of the threaded portion further restricts withdrawal.

FIG. 2 represents an alternative fixing arrangement for a tag transponder, which is generally similar to that of FIG. 1. However, in this case, a receiving component is provided to make up a two-part tag, which is so configured that it is not readily detachable once the parts are attached.

In the figure the tag comprises two portions, a male portion (11) and female portion (12).

The male portion (11) again comprises a disc of rigid plastic material which entirely encapsulates RFID coil (18). The female portion (12) comprises a disc of plastic material which is provided with a recess (14) intended to receive the perpendicular projection from the male portion (11).

In this design, the projecting portion consists of a threaded portion (15) and an unthreaded shank (16). The shank is of greater longitudinal extent than the combination of the thickness of the fabric (17) and the thickness of the female portion (12).

In use the threaded portion threads its way through the fabric (17) and the recess (14) in the female element (12) when rotated. As it is rotated, the threaded portion self-taps its way through the fabric and through the recess in the female element (14). Once the thread portion is completely through the fabric and the female element, the plain portion sits within the hole created by the recess in the female element and in the cloth, creating the sandwich arrangement of FIG. 2(b). The unthreaded shank (16) freely rotates within this hole, and the screw mechanism is thus not readily reversed once it is fully engaged. Additionally, the shape of the threaded portion (15), and in particular the reward face (19), are such as to tend to make extraction of the threaded portion irreversible under action of the thread or under rotation of the assembly.

Thus, the threaded embodiment of FIG. 2 again enables the tag to be simply but permanently and stably fixed to the laundry item.

In use, a plurality of such tags each carrying a unique identifier are provided, for example for identification, tracking or authentication purposes. A suitable data reader with a suitable radio frequency transmitter and receiver is able to read a unique identifier given to each tag.

A data register, for example on a computer, on site or remote via a data communications link, stores information associated with each unique tag identification number, which can be used to identify an item, to locate an item, to authenticate an item etc. The relatively small amount of data stored on the tag itself thus gives access to much greater functionality via the database.

1. An attachable RFID tag comprises a containment head portion containing a passive RFID transponder and an attachment portion comprising an elongate projection therefrom, which projection is discontinuously threaded, with a screw-threaded portion located generally distally of the containment head and an unthreaded portion provided between the threaded portion of the projection and the containment head portion.

2. A tag in accordance with claim 1 wherein the unthreaded shank portion has a longitudinal extent at least the thickness of the item to be tagged.

3. A tag in accordance with claim 1 wherein the threaded portion is tapered towards the distal end to facilitate engagement with an item to be tagged.

4. A tag in accordance with claim 1 wherein the threaded portion presents a generally planar reward engagement face to inhibit disengagement from an item to be tagged in the form of a circumferential detent at an end of the threaded portion proximal to the head, immediately adjacent the unthreaded portion, in that the threaded portion at this point is of greater cross sectional area than the unthreaded portion.

5. A tag in accordance with claim 1 provided in conjunction with a complementarily recessed tag receiving unit, which tag receiving unit comprises a body portion having a through aperture therein to receive the partially threaded projection of the tag.

6. A tag in accordance with claim 5 wherein the through aperture in the complementarily recessed tag receiving unit is threaded.

7. A tag in accordance with claim 1 wherein the head portion containing the RFID transponder is disc like, with the RFID comprising a coil disposed toward the circumference of the disc, around a centrally located projection extending generally perpendicularly thereto.

8. A tag in accordance with claim 7 wherein the tag comprises a generally flat disc having a projecting member extending generally perpendicularly from a centre thereof, and is provided with a tag receiving unit comprising a generally flat annulus with a centrally located aperture suitably sized and shaped to receive the said projection.

9. A tag in accordance with claim 1 wherein the head portion containing the RFID transponder has a maximum dimension of less than 15 mm.

10. A tag in accordance with claim 1 wherein the RFID coil is encapsulated entirely within the containment portion of the tag.

11. A tag in accordance with claim 1 wherein the casing material of the tag comprises polymeric material.

12. A tagging kit comprising a plurality of tags in accordance with claim 1 each carrying an identifier, and further provided with at least one tag reader including a suitable radio frequency transmitter and receiver to read the identifier given to each tag.

13. A tagging kit in accordance with claim 12 further including a tag attachment device that assists in driving the thread into its attached position where the unthreaded portion is free to rotate.

14. A multi-item management system, comprises a tagging kit in accordance with claim 12 and further comprising a data register to store information associated with each tag identification number.

15. A multi-item management system in accordance with claim 14 further comprising a data communications link to facilitate data communication between a tag reader and the data register, and a display means to display information to a user.

16. A method of tagging an item and for example an item of laundry to enable its tracking comprising:
fabricating a tag having a partially threaded projecting portion in accordance with claim 1;
incorporating therewithin in the containment head thereof, and in particular encapsulating therewithin a passive RFID transponder;
attaching the tag by causing the projecting portion to rotate and driving the same into an item to be tagged until the threaded portion passes through the item to be tagged and the unthreaded portion is left freely to rotate therewithin, such as to effect a fixed and permanent attachment of the tag to the item.

17. A method of operation of a tagging system to identify data concerning an item in a series of items comprising:
attaching a tag to each item in a series of items in accordance with the method of claim 16;
providing at least one radio frequency tag reader capable of reading the identifier on each tag;
providing a data register in data communication link with the said tag reader to store information relating to each identifier, for example including at least the owner of the laundry item;
as and when necessary, reading the tag with the reader,
retrieving the identifier, passing the identifier to the data register via the data communication link, and thereby retrieving at least some of the stored information related to the item.
